(19) United States
(12) Patent Application Publication
(10) Pub. No.: US 2019/0128647 A1
(43) Pub. Date: May 2, 2019

(54) LIGHT WEIGHT COATED FABRICS AS TRAUMA REDUCING BODY ARMOR

(71) Applicant: E.I. DU PONT DE NEMOURS AND COMPANY, Wilmington, DE (US)

(72) Inventors: Atanu Acharya, West Bengal (IN); Kannadhasan Raji, Tamil Nadu (IN); Nivedita Sangaj, Maharashtra (IN); Ravi Sriraman, Tamil Nadu (IN)

(21) Appl. No.: 16/086,360

(22) PCT Filed: Apr. 25, 2017
(86) PCT No.: PCT/US17/29259

§ 371 Date: Sep. 19, 2018

Related U.S. Application Data
(60) Provisional application No. 62/332,545, filed on May 6, 2016.

(51) Int. Cl. F41H 5/04; B32B 5/26; F41H 1/02

(52) U.S. Cl. CPC F41H 5/0485; B32B 5/26; B32B 2571/02; B32B 2255/26; B32B 2255/02; F41H 1/02

(57) ABSTRACT

A ballistic resistant vest comprises a plurality of resin coated fabrics wherein (i) the fabric further comprises continuous filament yarns having a tenacity of 900 mPa and having a linear density of 444-1111 dtex, (ii) the resin coating is a blend of 10-90% of an ionomer and 90-10% of polyvinyl alcohol and has a viscosity of from 80 to 1700 centipoise, and (iii) the resin comprises from 3 to 13 weight percent of the weight of the resin coated fabric.

### FIELD OF THE INVENTION

This invention relates to trauma reducing laminates containing coated fabrics particularly suitable in ballistic resistant soft body armor and a method of their manufacture.

### BACKGROUND OF THE INVENTION

The primary objective of body armor research is to develop a low cost, light-weight, comfortable to wear system with ballistic-impact resistance. Body armor standards vary from country to country. The primary requirement is to stop the projectile and to have low trauma. This trauma value can vary from 44 mm to 25 mm depending upon the armor standards. If penetration depth exceeds this value, a wearer can incur serious blunt trauma. Aramid and ultra-high molecular weight polyethylene (UHMWPE) have been used as base materials for ballistic protection. These high performance fibers are characterized by low density, high strength, and high energy absorption. However, to meet the protection requirements for typical ballistic threats, approximately 20-50 layers of fabric are required depending upon the type of fabric used. The resulting armor becomes heavy and may not meet the low trauma requirement. An objective of the current invention is to achieve a trauma value of 25 mm or below.

In tests such as NIJ 0101.06 of July 2007: “Ballistic Resistance of Personal Body Armor”, the depth of the backface signature on a clay box upon impact of a projectile is used as a means to quantify the severity of the blow, or trauma, to which a hypothetical wearer would be subjected.

There are several literature reports citing ways to manufacture ballistic armors that diminish the blow suffered by a person upon projectile impact.

Several approaches have been used in design and materials to circumvent this problem. In the design part, a combination of ballistic-resistant material and trauma reducing materials may be used. Ballistic-resistant material may contain different fabric structures e.g. multi directional, unidirectional, nonwoven and fiber-reinforced composites to get better ballistic performance. Trauma reduction material is based on use of non-ballistic or a combination of ballistic and non-ballistic materials such as ABS or PC sheets, foams of various thicknesses etc.

US Patent Application Publication 2005/0282007 describes effect of coating Kevlar® fabric with Vamac® VCD and other resins to reduce trauma.

Rosen et al., in the Proceedings of SAMPE 2007, Baltimore Md., 3-7 Jun. 2007 describe the use of shear thickening fluid (STF) such as silica suspension to reduce blunt trauma of a solution.

The solutions reported in the art suffer from several deficiencies like stiffer and non-ballistic material leading to unpredictable failure when used for long period of time, limited response time for shear thickening fluids, poor ballistic performance of STF coated fabric when used in a ballistic pack and complicated coating process and handling of STF material.

Thus, there is a strong felt need for improved resins for coating ballistic fabrics to prepare better performing soft armor panels that provides higher protection from blunt trauma and that increases survival rates when compared to the soft armor panels known in the art, and are comfortable to wear.

### SUMMARY OF THE INVENTION

An aspect of the present invention is a ballistic resistant vest, comprising a plurality of resin coated fabrics wherein

(i) the fabric further comprises continuous filament yarns having a tenacity of 900 mPa and having a linear density of 444-1111 dtex,

(ii) the resin coating is a blend of 10-90% of an ionomer and 90-10% of polyvinyl alcohol and has a viscosity of from 80 to 1700 centipoise, and

(iii) the resin comprises from 3 to 13 weight percent of the weight of the resin coated fabric.

Another aspect of the present invention is a process of making a coated fabric comprising

(i) pouring a coating solution on the fabric

(ii) uniformly spreading the coating

(iii) removing excess coating, and

(iv) drying the coating fabric at 80-100° C. for 10-15 minutes,

wherein the coating comprises a blend of 10-90% of an ionomer and 90-10% of polyvinyl alcohol and has a viscosity of from 80 to 1700 centipoise, the coating being present in an amount such that the coating comprises from 3 to 13 weight percent of the weight of the resin coated fabric.

### DETAILED DESCRIPTION

The soft armor laminate panel of this invention suitable for resisting a ballistic object contains a plurality of layers comprising at least one aramid fabric layer either uncoated or coated with resin(s) bonded together with another fabric or sheet layer with adhesive.

In some embodiments, the aramid fabric layer used in the ballistic resistant multilayer laminated structures according to the present invention is made of continuous filament yarns which are made of fibers. For purposes herein, the term “fiber” is defined as a relatively flexible, macroscopically homogeneous body having a high ratio of length to width across its cross-sectional area perpendicular to its length. The fiber cross section can be any shape, but is typically round. Herein, the term “filament” is used interchangeably with the term “fiber”.

By “aramid”, it is meant a polyamide wherein at least 85% of the amide (—CONH—) linkages are attached directly to two aromatic rings. Suitable aramid fibers are described in Man-Made Fibers—Science and Technology, Volume 2,

Section titled Fiber-Forming Aromatic Polyamides, page 297, W. Black et al., Interscience Publishers, 1968. Aramid fibers and their production are, also, disclosed in U.S. Pat. Nos. 4,172,938; 3,869,429; 3,819,587; 3,673,143; 3,354,127; and 3,094,511. The preferred aramid is a para-aramid. The preferred para-aramid is poly (p-phenylene terephthalamide) which is called PPD-T.

The fabric may be woven, unidirectional, multidirectional, including bidirectional, or nonwoven.

By “unidirectional (UD) fabric” is meant a fabric layer (ply) in which the component yarns or fibers are aligned in a parallel direction within the plane of the fabric.

By “multidirectional fabric” is meant a fabric comprising a plurality of unidirectional fabric layers in which the orientation of the yarns or fibers in one UD fabric layer is offset with respect to the orientation of yarns or fibers in the next layer. In one embodiment, the “multidirectional aramid” fabric of the invention comprises two layers of unidirectional fabric of para-aramid yarns with the yarns aligned in a +45/−45° orientation with respect to the machine direction of the fabric. The multidirectional fabric further comprises a polyester yarn binding thread stitched through the UD fabric layers in a direction orthogonal to the plane of the UD fabric layers. The machine direction is the long direction within the plane of the fabric, i.e. the direction in which the fabric is being produced by the machine. A multidirectional fabric comprising two layers of unidirectional fabric is also known as a bidirectional fabric.

The term “nonwoven” means here a web including a multitude of randomly oriented fibers. By “randomly oriented” is meant that the fibers have no long range repeating structure discernable to the naked eye. The fibers can be bonded to each other, or can be unbonded and entangled to impart strength and integrity to the web. The fibers can be staple fibers or continuous fibers, and can comprise a single material or a multitude of materials, either as a combination of different fibers or as a combination of similar fibers each comprised of different materials.

Nonwoven fabrics or webs have been formed from many processes such as for example, melt blowing processes, spun bonding processes, and bonded carded web processes.

As used in this application, the term “high modulus” refers to materials having a modulus greater than 500 grams per denier (gpd). Suitable coatings according to the present invention may be chosen from water soluble ionomers or polyvinyl alcohol or blends of these. The acid groups in ionomers are neutralized fully or partially with neutralizing agents such as sodium, potassium, zinc, magnesium, lithium and combinations thereof. Suitable resins for use in the present invention are commercially available under the trademark Surlyn® from E. I. du Pont de Nemours and Company, Wilmington, Del., USA.

One aspect of the present invention is a ballistic resistant vest, comprising a plurality of resin coated fabrics wherein

(i) the fabric further comprises continuous filament yarns having a tenacity of 900 mPa and having a linear density of 444-1111 dtex,

(ii) the resin coating is a blend of 10-90% of an ionomer and 90-10% of polyvinyl alcohol and has a viscosity of from 80 to 1700 centipoise, and

(iii) the resin comprises from 3 to 13 weight percent of the weight of the resin coated fabric.

A further aspect of the invention is a process of making a coated fabric comprising

(i) pouring a coating solution on the fabric

(ii) uniformly spreading the coating

(iii) removing excess of coating, and

(iv) drying the coating fabric at 80-100° C. for 10-15 minutes,

wherein the coating comprises a blend of 10-90% of an ionomer and 90-10% of polyvinyl alcohol and has a viscosity of from 80 to 1700 centipoise, the coating being present in an amount such that the coating comprises from 3 to 13 weight percent of the weight of the resin coated fabric.

The resin coated fabrics are used in conjunction with other components to make a soft body armor protective article to protect areas of the body such as a front body, a back body, a groin, a neck or a shoulder.

Hook-and-loop fastener materials on the front and back body articles provide pockets for receiving packs of ballistic-resistant resin coated fabrics and optionally a trauma pack. The resin coated packs may further be covered by a water repellent coated fabric.

In another embodiment, the ionomer is an ethylene-methacrylic acid copolymer. In a preferred embodiment, the acid groups of ionomer are neutralized fully or partially with sodium. In another preferred embodiment, the acid groups of ionomer are neutralized with 50-70% sodium. In yet another embodiment of the present invention, the viscosity of the resin is between 80 to 1700 centipoise.

In another embodiment, the resin is coated on the fabric in an amount of between 1 to 10% by weight based on the combined weight of fabric plus resin. In another embodiment of the present invention, the aerial density of the ballistic resistant material is less than 5 kg/m².

In another embodiment of the present invention, the water repellent coated fabric is polyamide.

### Test Methods

Temperature: All temperatures were measured in degrees Celsius (° C.).

Linear Density: The linear density of a yarn or fiber was determined by weighing a known length of the yarn or fiber based on the procedures described in ASTM D1907/D1907M-12 and D885/D885M-10a (2014). Decitex or “dtex” is defined as the weight, in grams, of 10,000 meters of the yarn or fiber. Denier (d) is 9/10 times the decitex (dtex).

Tensile Properties: The fibers to be tested were conditioned and then tensile tested based on the procedures described in ASTM D885/D885M-10a (2014). Tenacity (breaking tenacity), modulus of elasticity, force to break and elongation to break are determined by breaking test fibers on an Instron universal test machine.

Areal Density: The areal density of the fabric layer was determined by measuring the weight of one square meter of fabric i.e., 1 m×1m. The areal density of a composite structure was determined by the sum of the areal densities of the individual layers.

Melt Flow Index was measured as per ASTM D 1238-13.

Viscosity of Solution: The viscosity of the individual polymer solution and that of a blend was measured using Haake Viscotester C model from Thermoscientific India wherein spindles TR8 and TR9 were used. The viscosity and corresponding torque of the solution were measured at 25° C.

The environmental conditioning protocol consisted of exposing body armor to environmental conditioning inside a chamber wherein the temperature and relative humidity are maintained at 65±2° C. and 80±5% respectively for 10 days. Conditioned soft body armor was tested in a ballistic test for backface signature. The value of backface signature of soft body armor should be less than 25 mm before and after conditioning.

Trauma Test Method (Back Face Deformation or BFD)

The body armor containing a ballistic pack and trauma pack was fastened to a clay box of Roma No 1 clay, with the ballistic pack facing away from the clay and then subjected to a ballistic impact by a 9×19 mm bullet (OFB, India) traveling at a speed of 400±15 m/s, shot from a distance of 5 meters. Back face deformation is also known as Back Face Signature.

After the bullet hit the pack, the depth of crater created on the clay was measured and recorded as the back face signature (or trauma); For each test sample, the test was average of 3 panels with 3 shots each.

### Description of Layers

Fabric layers and coatings of the following description were used for preparing the multilayer laminated composite trauma pack;

Kevlar® 802 fabric was a textile fabric having a plain weave and having areal density of 190 g/m², consisting of poly (p-phenylene terephthalamide) yarns having a linear density of 1000 denier and 8.5×8.5 ends per centimeter available from E. I. du Pont de Nemours and Company, Wilmington, Del., USA (hereinafter DuPont) under the trade name of Kevlar® para-aramid and was cut into 210×297 mm sheets.

Surlyn® HPD 3001 is a water dispersible ionomer resin having a melt flow index (MFI) of 2 g/10 min at 190° C. and a melting point of 83° C. The ionomer comprises about 19-23% acrylic/methacrylic acid moieties as a comonomer with about 59-60% neutralized with sodium cation.

Elvanol® 90-50 is a fully hydrolyzed grade of polyvinyl alcohol having viscosity of 11.6-15.4 cps at 4 wt % concentration at 20° C.

PVB is polyvinyl butyral available under the tradename of Synapol B 60 from Synapol Products, India. The PVB content is nominally 76-81% by weight and the PVOH content is 16-20% by weight. The T_{g} is about 69° C. and the viscosity is 60 cps at 50 rpm.

Vamac VCD 6200 is a copolymer of ethylene and methacrylic acid (38/62 w/w) having a T_{g} of about −32° C.

Michem Prime 2960 from Michelman Inc., USA is an ethylene acrylic acid copolymer dispersion (ammoniated) with 10% mole acrylic acid neutralized 100% with potassium and a viscosity <500 cps.

### EXAMPLES

Examples prepared according to the process or processes of the current invention are indicated by numerical values. Control or Comparative Examples are indicated by letters. The assembly configurations are described in the following text and tables. Data and test results relating to the Comparative and Inventive Examples are shown in Tables 1-3.

### Preparation of Coating Solutions

### Comparative Example A

A water soluble ionomer solution of Surlyn HPD 3001 was prepared by dispersing a weighed amount of Surlyn HPD 3001 pellets (about 25 gm) in 75-80 ml water. The solution was heated at temperature of 90-95° C. with continuous stirring at about 300 rpm till a clear solution was obtained. The solid content of the solution was determined by drying a weighed amount of solution (w1) at 100° C. for 2 hrs and weighing the solid residue left (w2).
The solid content was found by using the following formula;

% A solid content of solution=(w2/w1)×100

### Comparative Example B

Water soluble Elvanol® solution was prepared by a method described in Example 1 by dissolving about 15 gm of Elvanol® (90-50 granules) in 85 ml water by heating at 90-95° C. with continuous stirring till the clear thick solution was obtained. The solids content of Elvanol® solution was found out similarly.

### Example 1

A 90:10 blend solution of Surlyn® and Elvanol® solution was prepared as described in example 1 by mixing 50 gm of Surlyn® solution with 83.4 gm of Elvanol® solution.

### Example 2

A 50:50 blend solution of Surlyn® and Elvanol® solution was prepared as described in Example 1 by mixing 50 gm of Surlyn® solution with 9.25 gm of Elvanol® solution.

### Example 3

A 10:90 blend solution of Surlyn® and Elvanol® solution was prepared as described in Example 1 by mixing 50 gm of Surlyn® solution with 750 gm of Elvanol® solution.
The viscosity of the coating solutions prepared in the Comparative Examples A and B and Examples 1-3 is shown in Table 1.

TABLE 1

| Example | % Resin Content | Viscosity (cp) | Torque (%) |
|---|---|---|---|
| Comparative | 25 | 28 | 11 |
| Example A | | | |
| Comparative | 14.2 | 1690 | 68 |
| Example B | | | |
| 1 | 23.6 | 89 | 36 |
| 2 | 19.8 | 517 | 41 |
| 3 | 15.8 | 1661 | 57 |

### Fabric Coating

### Example 4

Kevlar® 802 fabric of 190 gsm was coated to a 2% resin content of Example 1 according to the method now described. The solution was coated on the fabric by pouring the solution on the fabric followed by spreading uniformly by travel of the bar on the fabric. Excess resin was removed from the fabric by sweeping it off with a coating bar. The residence time of the fabric in the bath and/or the speed of application of the solution was adjusted to provide the desired amount of resin coating on the fabric. The coated fabrics were dried by heating at 100 degrees C. in an oven. The drying time was based on the time required to get a constant weight of dried fabric and was from 10 to 15 minutes depending upon the solids content of the resin blend or resin solution. Resin content of the fabric was determined by weighing the fabric before application and after application followed by drying of the fabric to drive out water.

### Example 5

Kevlar® 802 fabric of 190 gsm was coated to a 3% resin content of Example 1 coating according to the method described in Example 4.

### Example 6

Kevlar® 802 fabric of 190 gsm was coated to a 4% resin content of Example 1 coating according to the method described in Example 4.

### Example 7

Kevlar® 802 fabric of 190 gsm was coated to a 4% resin content of Example 2 coating according to the method described in Example 4.

### Example 8

Kevlar® 802 fabric of 190 gsm was coated to a 4% resin content of Example 3 coating according to the method described in Example 4.

### Example 9

Kevlar® 802 fabric of 190 gsm was coated to a 7% resin content of Example 1 coating according to the method described in Example 4.

### Example 10

Kevlar® 802 fabric of 190 gsm was coated to a 10% resin content of Example 1 coating according to the method described in Example 4.

### Example 11

Kevlar® 802 fabric of 190 gsm was coated to a 13% resin content of Example 1 coating according to the method described in Example 4.

### Comparative Example C

Kevlar® 802 fabric of 190 gsm was coated to a 4% resin content of PVB coating according to the method described in Example 4.

### Comparative Example D

Kevlar® 802 fabric of 190 gsm was coated to a 4% resin content of Vamac® VCD 6200 coating according to the method described in Example 4.

### Comparative Example E

Kevlar® 802 fabric of 190 gsm was coated to a 4% resin content of Michem Prime 2960 coating according to the method described in Example 4.

### Comparative Example F

Kevlar® 802 fabric of 190 gsm was coated to a 4% resin content of Comparative Example B coating according to the method described in Example 4.

### Comparative Example G

Kevlar® 802 fabric of 190 gsm was coated to a 7.23% resin content of Comparative Example A coating according to the method described in Example 4.

### Comparative Example H

Kevlar® 802 fabric of 190 gsm was coated to a 7.48% resin content of Comparative Example B coating according to the method described in Example 4.

### Preparation of Test Specimens

For preparing soft body armor (SAP) for test, the aerial density of the SAP was maintained at a nominal 4.5 kg/m².

### Control A

A stack of 24 layers of Kevlar® 802 fabric of 190 gsm was used as the soft armor panel without any coated fabric. The aerial density of the SAP was 4.6 kg/m².

### Example 12

A stack of 23 layers of Example 4 coated fabric was used as the soft armor panel. The aerial density of the SAP was 4.5 kg/m².

### Example 13

A stack of 23 layers of Example 5 coated fabric was used as the soft armor panel. The aerial density of the SAP was 4.5 kg/m².

### Example 14

A stack of 23 layers of Example 6 coated fabric was used as the soft armor panel. The aerial density of the SAP was 4.6 kg/m².

### Example 18

A stack of 22 layers of Example 7 coated fabric was used as the soft armor panel. The aerial density of the SAP was 4.5 kg/m².

### Example 19

A stack of 22 layers of Example 8 coated fabric was used as the soft armor panel. The aerial density of the SAP was 4.6 kg/m².

### Example 15

A stack of 23 layers of Example 9 coated fabric was used as the soft armor panel. The aerial density of the SAP was 4.5 kg/m².

### Example 16

A stack of 23 layers of Example 10 coated fabric was used as the soft armor panel. The aerial density of the SAP was 4.6 kg/m².

### Example 17

A stack of 23 layers of Example 11 coated fabric was used as the soft armor panel. The aerial density of the SAP was 4.6 kg/m².

### Comparative Example I

A stack of 23 layers of Comparative Example C coated fabric was used as the soft armor panel. The aerial density of the SAP was 4.6 kg/m².

### Comparative Example J

A stack of 23 layers of Comparative Example D coated fabric was used as the soft armor panel. The aerial density of the SAP was 4.6 kg/m².

### Comparative Example K

A stack of 23 layers of Comparative Example E coated fabric was used as the soft armor panel. The aerial density of the SAP was 4.6 kg/m².

### Comparative Example L

A stack of 23 layers of Comparative Example F coated fabric was used as the soft armor panel. The aerial density of the SAP was 4.6 kg/m².

### Comparative Example M

A stack of 23 layers of Comparative Example G coated fabric was used as the soft armor panel. The aerial density of the SAP was 4.6 kg/m².

### Comparative Example N

A stack of 23 layers of Comparative Example H coated fabric was used as the soft armor panel. The aerial density of the SAP was 4.6 kg/m².

### Example 20

A stack of 12 layers of Example 12 coated fabric and 12 layers of control

A was used as the soft armor panel. The aerial density of the SAP was 4.6 kg/m2.

### Example 21

A stack of 11 layers of Example 13 coated fabric and 12 layers of control A was used as the soft armor panel. The aerial density of the SAP was 4.5 kg/m².

### Example 22

A stack of 7 layers of Example 14 coated fabric and 16 layers of control A was used as the soft armor panel. The aerial density of the SAP was 4.5 kg/m².

### Example 23

A stack of 11 layers of Example 14 coated fabric and 12 layers of control A was used as the soft armor panel. The aerial density of the SAP was 4.5 kg/m².

### Comparative Example 0

A stack of 12 layers of Comparative Example L coated fabric and 12 layers of control A was used as the soft armor panel. The aerial density of the SAP was 4.7 kg/m².

### Ballistic Trauma Test

A 210×297 mm SAP was used for testing. A ballistic pack of SAP was prepared by stacking the required number of Kevlar® (coated/uncoated) fabrics and stitching through the fabrics with a ½″ box stitch. One layer of non-ballistic foam of XLPE (cross-linked polyethylene) having an areal density of 100 g/m² and a thickness of 4 mm was used as a backing. Each stack was fastened to a clay box of Roma No 1 clay, with the ballistic pack facing away from the clay and then subjected to a ballistic impact by a 9×19 mm bullet (OFB, India) traveling at a speed of 400±15 m/s, shot from a distance of 5 meters.

The test samples consisted of a soft armor panel according to Examples 12-23.

The comparative test samples consisted of soft armor panels according to Control A and comparative examples H—O in order to achieve a comparable areal density to Examples 12-23.

After the bullet hit the stack, the depth of crater created on the clay was measured and recorded as the back face signature (or trauma); the results are shown in Tables 2 and 3. For each test sample, the test was average of 3 panels with 3 shots each.

TABLE 2

| | | Aerial | Back Face Trauma | |
|---|---|---|---|---|
| | | Density | Mean | Std. |
| Example | No. of Layers | (kg/m²) | (mm) | Dev. |
| Control A | 24 | 4.6 | 42 | 0.3 |
| Comparative | 23 | 4.6 | 25.2 | 3 |
| Example I | | | | |
| Comparative | 23 | 4.6 | 32.5 | 3.5 |
| Example J | | | | |
| Comparative | 23 | 4.6 | 25.3 | 3.5 |
| Example K | | | | |
| Comparative | 23 | 4.6 | 25.7 | 3.5 |
| Example L | | | | |
| Comparative | 23 | 4.6 | 27.5 | 3.3 |
| Example M | | | | |
| Comparative | 23 | 4.6 | 31.5 | 3.6 |
| Example N | | | | |
| Example 12 | 23 | 4.5 | 29.7 | 3.9 |
| Example 13 | 23 | 4.5 | 34.2 | 1.5 |
| Example 14 | 23 | 4.6 | 24.9 | 3.3 |
| Example 15 | 22 | 4.5 | 25.1 | 3.6 |
| Example 16 | 22 | 4.6 | 24.1 | 1.6 |
| Example 17 | 21 | 4.5 | 21 | 1.3 |
| Example 18 | 23 | 4.6 | 35.8 | 1.6 |
| Example 19 | 23 | 4.6 | 40.3 | 1.7 |

TABLE 3

| | No. of | No. of | Aerial | Back Face Trauma | |
|---|---|---|---|---|---|
| | Uncoated | Coated | Density | Mean | |
| Example | Layers | Layers | (kg/m²) | (mm) | Std. Dev. |
| Control A | 24 | 0 | 4.6 | 42 | 0.3 |
| Comparative | 12 | 12 | 4.7 | 29.4 | 2.2 |
| Example O | | | | | |
| Example 20 | 12 | 12 | 4.6 | 29.9 | 1.9 |
| Example 21 | 12 | 11 | 4.5 | 29.4 | 2.2 |
| Example 22 | 16 | 7 | 4.5 | 34.3 | 3.5 |
| Example 23 | 12 | 11 | 4.5 | 30.1 | 2.9 |

### Observations:

As can be seen from Table 2, Examples 13-17 suggest that as the coating of the 90:10 blend was gradually increased from 3 to 13%, the BFD values reduced which shows that the coatings have a direct effect on the trauma. This, when compared with a 7% coating for Surlyn® (Comparative Example M) and Elvanol® (Comparative Example N), clearly shows that the coating shows improved trauma over the comparative coating without compromise on the fabric weight.

However, when a stack with both coated and uncoated fabrics was tested for BFD, as shown in Table 3, Comparative Example 0 with 12 layers of 4% Elvanol® coated fabric and 12 layers of uncoated fabric shows similar BFD values as Example 20 with 11 layers of 4% 90:10 blend coated fabric and 12 layers of uncoated fabric. This indicated that use of a mix of coated and uncoated fabric does not provide any improvement.

As can be seen from Table 2, Examples 12-17 with inventive coating shows better performance in terms of low trauma and low weight than the comparative coated fabrics.

### Environmental Conditioning Test Results

Each soft armor panel (SAP) was subjected to a temperature of 65±2° C. and relative humidity of 80±5% for 10 days. The environmentally conditioned SAP with one layer of non-ballistic foam XLPE based on cross linked polyethylene having an area density of 100 g/m² and a thickness of 4 mm was used for testing backface signature according to the following method.

The stack of SAP panels was fastened to a clay box of Roma No 1 clay, with the ballistic pack facing away from the clay box and then subjected to a ballistic impact of a 9×19 mm bullet (OFB, India) traveling at a speed of 400±15 m/s, shot from a distance of 5 meters. After the bullet impacted the stack, the depth of the back face signature was measured and recorded; the results are shown in Table 3. For each pack, the test was average of 3 panels with 3 shots each.

Soft body armor containing trauma pack as described above showed backface signature before and after environmental conditioning as shown in Table 4 below;

TABLE 4

| | Backface Signature (mm) | | | |
|---|---|---|---|---|
| | Before | | After | |
| | Conditioning | | Conditioning | |
| | | Std | | Std |
| Fabric | Average | Dev | Average | Dev |
| Control A | 42 | 0.3 | 44.2 | 1 |
| Example 14 | 24.9 | 3.3 | 27.1 | 1.4 |
| Comparative | 26 | 2.7 | 39 | 2.1 |
| Example L | | | | |

### Observations:

Since the final solution is required to pass the environmental conditioning test, performance of example 14 was further validated through environmental conditioning test as shown in Table 4 above, and it has been found to perform much better than the Comparative Example L.

TABLE 5

| | Aerial Density | BFD | V50 |
|---|---|---|---|
| Example | (kg/m²) | (mm) | (m/s) |
| Control A | 4.6 | 42 ± 0.3 | 500 |
| Example 14 | 4.6 | 24.9 ± 3.3 | 514 |
| Example 17 | 4.6 | 21.0 ± 1.3 | 453 |

The control SAP sample, Example 14 and Example 17 were tested for V50 and as evident from Table 5, the V50 was not compromised for the inventive samples.

We claim:

1. A ballistic resistant vest, comprising a plurality of resin coated fabrics wherein
(i) the fabric further comprises continuous filament yarns having a tenacity of 900 mPa and having a linear density of 444-1111 dtex,
(ii) the resin coating is a blend of 10-90% of an ionomer and 90-10% of polyvinyl alcohol and has a viscosity of from 80 to 1700 centipoise, and
(iii) the resin comprises from 3 to 13 weight percent of the weight of the resin coated fabric.

2. The vest of claim 1, wherein the fabric is woven, nonwoven, unidirectional or multidirectional.

3. The vest of claim 1, wherein the ionomer is an ethylene-methacrylic acid copolymer.

4. The vest of claim 1, wherein the acid groups of ionomer are neutralized fully or partially by a neutralizing agents selected from sodium, potassium, zinc, magnesium, lithium or combinations thereof.

5. The vest of claim 4, wherein the acid groups of ionomer are neutralized with 50-70% sodium.

6. The vest of claim 1, wherein the resin comprises from 4 to 10 weight percent of the weight of the resin coated fabric.

7. A ballistic resistant article comprising
(i) from 1 to 30 layers of fabric that is free of resin, wherein the fabric further comprises continuous filament yarns having a tenacity of 900 mPa and having a linear density of 444-1111 dtex, and
(ii) from 1 to 30 layers of the resin coated fabric of claim 1.
